(19) United States
(12) Patent Application Publication
(10) Pub. No.: US 2004/0247012 A1
(43) Pub. Date: Dec. 9, 2004

(54) Replacement method and device for assembling and disassembling modules of an electric arc furnace

(76) Inventor: Manfred Schubert, Oberhausen (DE)

Correspondence Address: FRIEDRICH KUEFFNER, 317 MADISON AVENUE, SUITE 910, NEW YORK, NY, 10017, US

(21) Appl. No.: 10/490,777

(22) PCT Filed: Sep. 13, 2002
(86) PCT No.: PCT/EP02/10266

(30) Foreign Application Priority Data
Oct. 6, 2001 (DE) 101 49 367.3

(51) Int. Cl. F27D 1/00; F27D 1/02

(52) U.S. Cl. 373/71; 373/73

(57) ABSTRACT

The invention concerns a replacement method and a device for assembling and disassembling modules of an electric arc furnace. Said method consists in lifting and pivoting the furnace cover or in only lifting it; when disassembling, it consists in removing the agent and power supply ducts as well as the instrument leads of the upper container (3) and/or of the lower container (2) and, after assembling in connecting them. The invention aims at enabling use of a low-power load crane and in significantly reducing replacement time. Therefor, once the lower container has been detached (2), the upper container (3) remains in its position, or once the energy agent supply ducts and the instrument leads have been detached, the upper container is lifted and detached by the loading crane. The lower container (2) is lifted then lowered and removed by a transport carriage (6) and, after the lower container has been replaced and introduced (2), the upper container (3) and the lower container (2) are once more connected, the agent and power supply ducts and the instrument leads previously detached are connected once more.

The invention concerns a method and a changing device for disassembling or assembling structural components of an electric arc furnace, in which the furnace cover is lifted and swung out or is only lifted, and in which the media and power supply lines and the measuring leads are disconnected from the upper vessel and/or the lower vessel during the disassembly and reconnected after the assembly.

Changing the furnace shell with a charging crane is a well-known operation. However, the only cranes that can be considered for this change are those with safe load capacities, which are considerably greater than those for handling the charging cage, e.g., 250 t instead of 120 t. The changing operation involves the following steps:

the furnace cover is lifted and swung out,

the media and power supply lines and the measuring leads are disconnected from the upper vessel,

a vessel transport traverse is mounted on the charging crane,

the upper vessel is lifted with the charging crane and moved to a set-down position,

the media and power supply lines and the measuring leads are disconnected from the lower vessel,

the lower vessel is lifted with the charging crane and moved to a set-down position,

a relined lower vessel is lifted and placed on the tilting frame,

the upper vessel is lifted and placed on the lower vessel,

the media and power supply lines and the measuring leads are reconnected to the upper and lower vessels.

This procedure is used, for example, in connection with working on the furnace shell in accordance with EP 0 049 926 A1.

The previously known procedure for disassembling or assembling the upper vessel and the lower vessel requires charging cranes with a high load capacity and takes several hours of work to accomplish. Therefore, the known method is very slow and very expensive with respect to the equipment that is needed. Charging cranes and crane tracks must be set up in advance for this type of work.

The objective of the invention is to be able to manage the operation by using a charging crane with a smaller load capacity and to achieve a significantly shorter changing time.

In accordance with the invention, this objective is achieved in the following way: After it has been separated from the lower vessel, the upper vessel either remains in its position or, after disconnection of the media and power supply lines and measuring leads, is lifted and moved out by the charging crane; the lower vessel is lifted and then lowered and moved out by a transporter; and after the vessel relining and after the lower vessel has been moved back in, the upper vessel and the lower vessel are rejoined after the disconnected media and power supply lines and measuring leads have first been reconnected. Therefore, a charging crane with an increased load capacity is no longer needed for the lower vessel. Since the upper vessel can remain in the furnace position and therefore the media and power supply lines and measuring leads no longer have to be disconnected and reconnected, a considerable amount of changing time can be saved.

In a refinement of this basic principle, a first procedure is proposed, which is characterized by the following steps:

the lower vessel and the upper vessel are lifted from an initial position (horizontal position),

a transporter with a lower vessel changing frame is moved under the lower vessel in the disassembly position,

the lower vessel and the upper vessel are lowered onto the transporter by a vessel lifting device,

the upper vessel is separated from the lower vessel and lifted again with the vessel lifting device, and

the lower vessel is moved out with the transporter.

This eliminates the crane work for the upper vessel, and due to the independently operating transporter, not only is time saved, but also the lower vessel is started towards a relining stand without having to unload it and load it again. Alternatively, the lower vessel is transferred by the transporter to within the operating range of the casting crane, which usually has a sufficient load capacity for the lower vessel, and transported by this crane to the relining stand.

Advantageous refinements provide that, on the transporter, which is waiting in the standby position in the tapping area, a lower vessel changing frame is adjusted to a transfer height in front of the lower vessel.

In this regard, the required introduction of force is achieved in such a way that detachable bolts (A, B) located on the vessel lifting device, which is supported on the periphery, are operated with a piston rod for joining or for detaching the lower vessel and/or the upper vessel. This makes it possible to lift or lower both vessels at the same time or separately.

In this regard, one refinement consists in lifting the upper vessel with the bolt (B) moved in.

The corresponding refinement provides that, with the bolts (A, B) moved in, the lower vessel and the upper vessel are lifted, or, with bolt A moved in, the lower vessel is lowered onto the transporter and moved out. With the upper vessel raised (bolt B is moved in) and with the lower vessel set down on the transporter (bolt A is moved out, i.e., disengaged), the lower vessel can be moved out.

In a refinement of the basic principle, a second advantageous procedure is proposed, which is characterized by the following steps:

a tilting bearing for a tilting frame is locked,

the upper vessel is lifted without disconnecting the media and power supply lines and the measuring leads,

the lower vessel is tilted out of the initial position into a position on the cradle bearing or tilting bearing,

a transporter with a lower vessel changing frame is moved under the lower vessel in the disassembly position,

the tilting frame is swung back into the initial position until the lower vessel has been set down on the lower vessel changing frame, and

the lower vessel is moved out to a relining stand by the transporter.

Here again, the parallel-operating devices not only save time, but also simplify the handling of the individual structural components.

In a refinement, it is also provided that the transporter with the lower vessel changing frame is held in the standby position in the tapping area.

Here again, therefore, only a single outfitting of a special transporter with the lower vessel changing frame is necessary. However, the transporter may also consist of a ladle transfer car.

The small stroke lengths for release or transfer to the following installation can be achieved in such a way that detachable bolts (A, B) located on the vessel lifting devices, which are supported on the periphery of the vessel, are operated with the piston rod for joining or detaching the lower vessel and/or the upper vessel.

To relieve the casting crane of the burden of transporting work in the steelworks, another (third) method is proposed, which is characterized by the following steps:

the lower vessel is moved on the transporter from the charging bay to the casting bay,

the transporter is turned on a turntable and moved on an aligned track to a first relining stand, and

the lower vessel is set down by lowering it into the first relining stand.

In this way, the presence of a crane in the casting hall is avoided from the start, and the lower vessel is positioned in the relining position with only a very small amount of lifting work.

Another (fourth) procedure for transporting the lower vessel to a relining stand without crane work is proposed, in which the lower vessel is lowered onto a cross-transfer car in the casting bay between two relining stands, the cross-transfer car is moved into one of the relining stands, and the lower vessel is set down. This makes it possible to bring at least two lower vessels into a relining stand and treat them at the same time.

The invention also concerns the changing device for the disassembly or-assembly of structural components of an electric arc furnace with a boom for the furnace cover and cradles or tilting bearings) for the tiltable furnace shell, which move with rolling contact on a bearing surface, and with means for moving out a vessel structural component.

In accordance with the invention, this goal is achieved by virtue of the fact that the furnace shell can be set in disassembly or assembly positions by means of a tilting cylinder-piston unit, which acts on a tilting frame, and/or by means of vessel lifting devices, which are distributed around the periphery of the furnace shell and can be joined with or detached from the lower vessel and/or the upper vessel. The tilting cylinder-piston unit and the vessel lifting devices advantageously serve to transfer the upper vessel and the lower vessel and are each supported on the foundation or on the tilting platform, occupy only a small amount of space and result in only a small amount of expense.

The transfer of the lower vessel is accomplished by assigning a transporter, which travels on tracks between the charging bay and the casting bay, to the tilting frame at the height level of the tilting frame.

Another refinement also serves the purpose of rapid transfer of the lower vessel and provides that the transporter together with a lower vessel changing frame can be moved at the level of the mill floor.

It is also advantageous for other means of handling that the transporter has a lower vessel changing frame that can be adjusted in height by means of several piston-cylinder units. This makes it possible to carry out transfer movements from the transporter itself.

The vessel lifting devices may be designed in such a way that each of the vessel lifting devices consists of a piston-cylinder drive, whose piston rod is provided with a device for adjusting the height and with releasable connecting devices for the lower vessel and/or the upper vessel. This makes it possible to move the upper vessel and the lower vessel together or individually in smaller strokes.

A modification provides that the tilting frame is supported at the opposite end from the tilting cylinder-piston unit by means of a lockable tilting bearing on a foundation block. The locking is effected for the vessel change and is used for tilting, i.e., for transferring, when the transporter moves under the lower vessel. During a melting operation, the locking mechanism is open.

A small tilting movement of a few degrees of arc can be made possible by supporting the lower vessel on the tilting frame by vessel feet that form convex support surfaces. This makes possible the slight swiveling movement by means of the vessel lifting means.

The transporter can take on other functions insofar as it can be moved from the charging bay on a casting bay track and then moved via a turntable into the first relining stand, in which the lower vessel can be set down or picked up again by means of the piston-cylinder units of the transporter.

The functions of the transporter can be applied to other tasks. In this regard, it is provided that the lower vessel can be moved by the transporter into a second relining stand, in which it can be transferred from the transporter to a cross-transfer car, from which the lower vessel can be set down or picked up again in the second relining stand.

A choice is possible in the relining stand in that the cross-transfer car can be optionally moved into two opposite relining stands.

Another modification of the invention provides that a transporter is designed as a movable relining stand with the basic shape of a U. The receipt or transfer of the lower vessel can occur as described. The transporter may serve as a station at any desired point in the charging bay or casting bay. In this case, only disassembly and reassembly of the lower vessel are necessary.

Various designs of the transporter, which constitutes the relining stand, can be advantageously used. For example, it is advantageous that in the basic U-shape the lower vessel is supported on the two legs of the U and on a cross frame joining the legs of the U.

In this regard, the disassembly direction or the assembly direction is taken into account by supporting the lower vessel between the legs of the U in the assembly position or the disassembly position. The process of moving up to the furnace position can be carried out so exactly that, after it has been accomplished, it is only necessary to carry out a lifting maneuver to complete the assembly.

The track wheels are aligned oriented accordingly. To this end, it is provided that the track wheels of the transporter are rotationally supported in pairs in the end regions of the legs of the U.

In addition, the available construction space can be utilized in such a way that a drive for the track wheels is installed in at least one of the legs of the U of the basic U shape.

The drawings illustrate embodiments of the invention, which are explained in greater detail below.

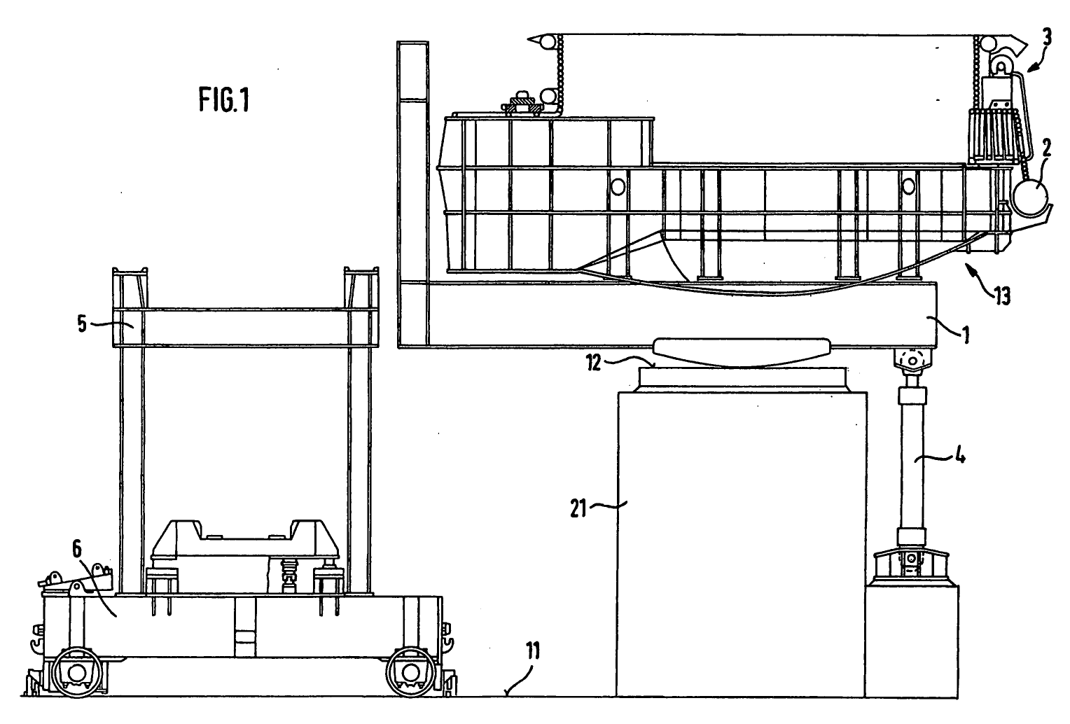

FIG. 1 shows an elevation of an electric arc furnace in the initial position with an associated transporter.

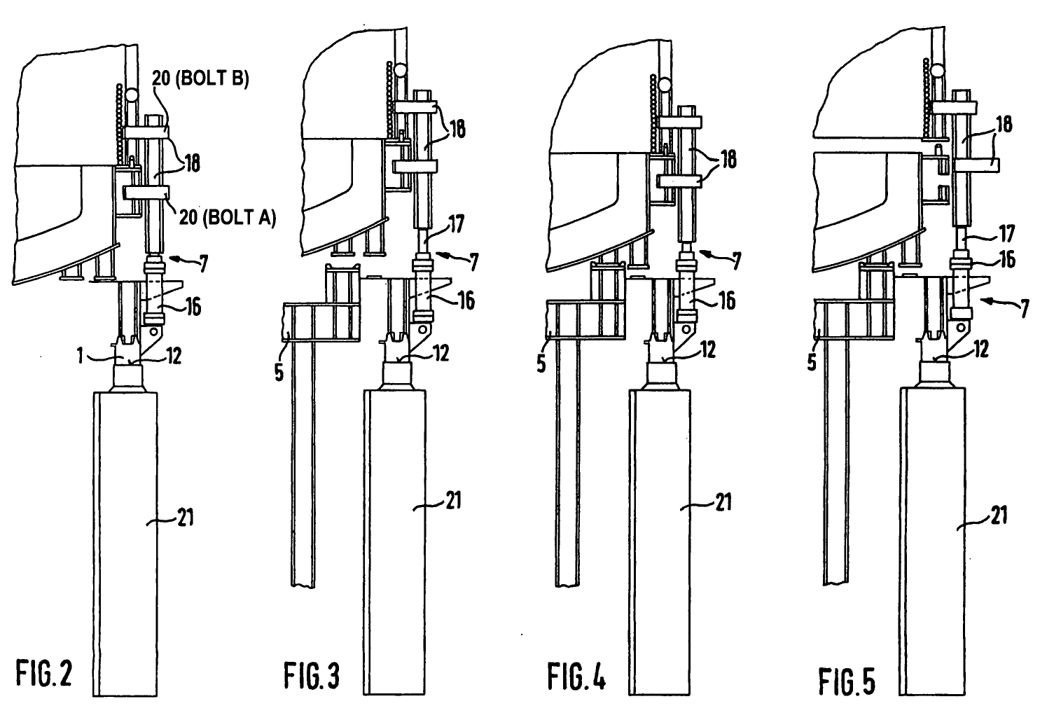

FIGS. 2 to 5 show elevations of the vessel lifting devices for various positions with respect to the upper vessel and the lower vessel.

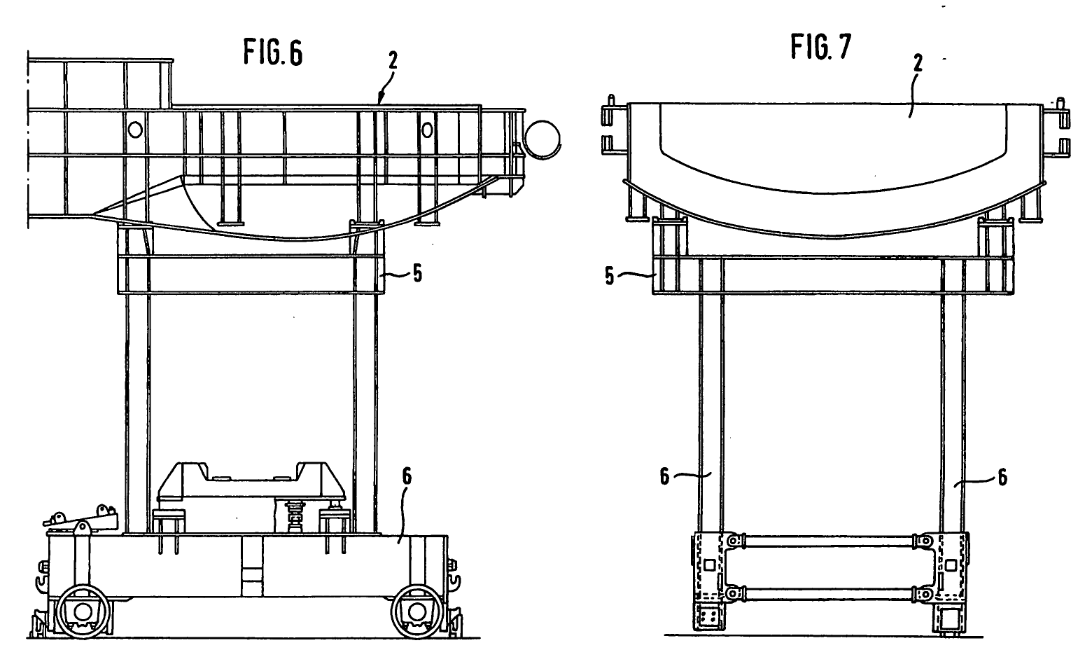

FIG. 6 shows a side view of the transporter with a lower vessel.

FIG. 7 shows a front view corresponding to FIG. 6.

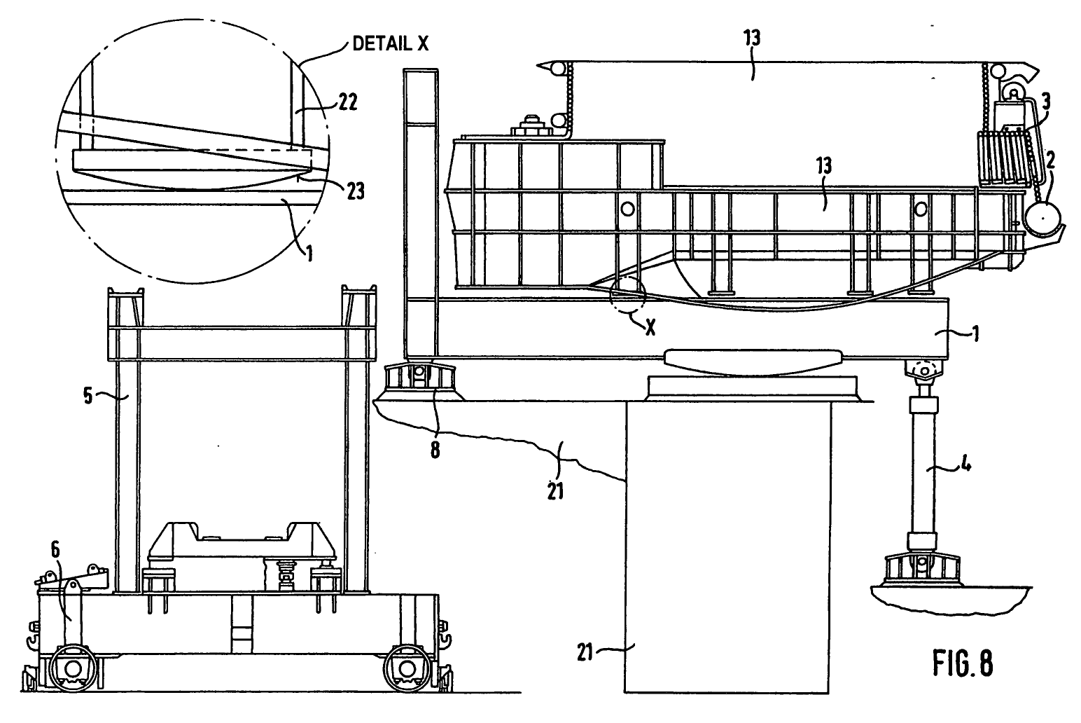

FIG. 8 shows an elevation of an alternative embodiment with lockable tilting bearing and a detail enlargement “X”.

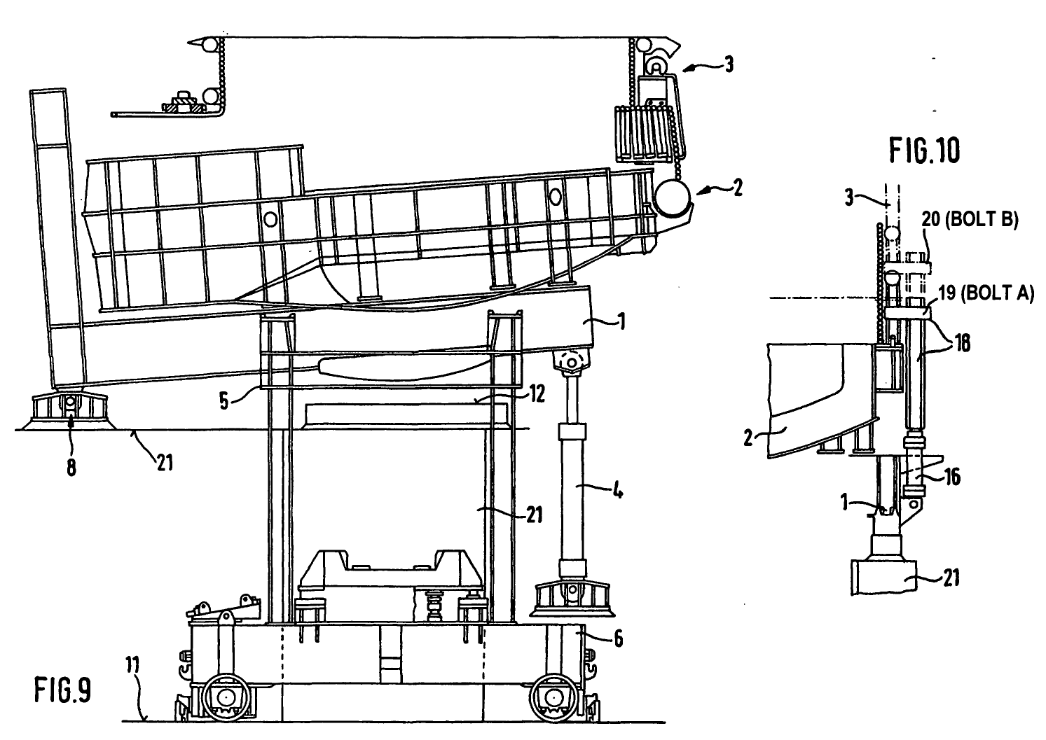

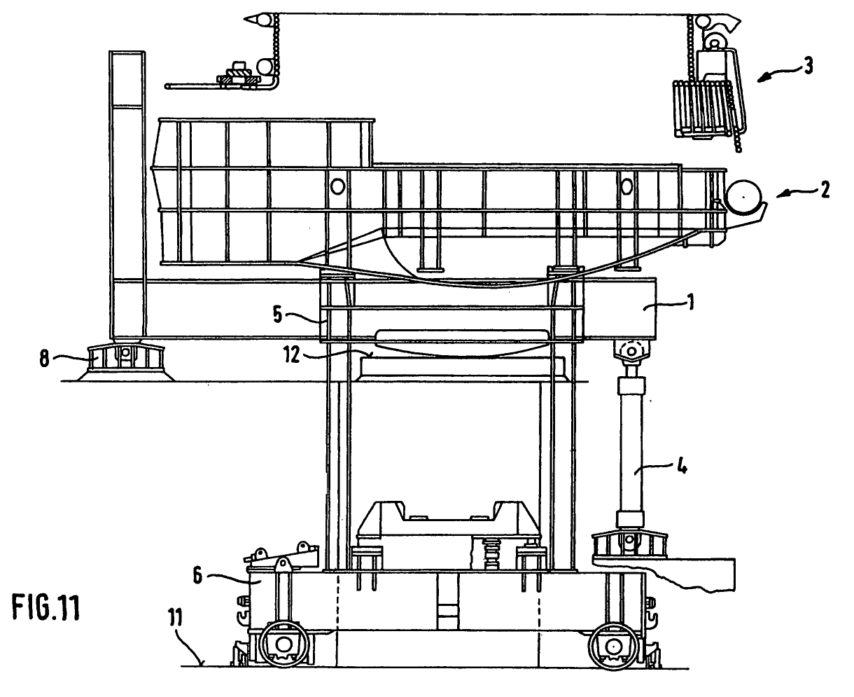

FIG. 9 shows an elevation of the lower vessel lifted by swiveling with the upper vessel detached.

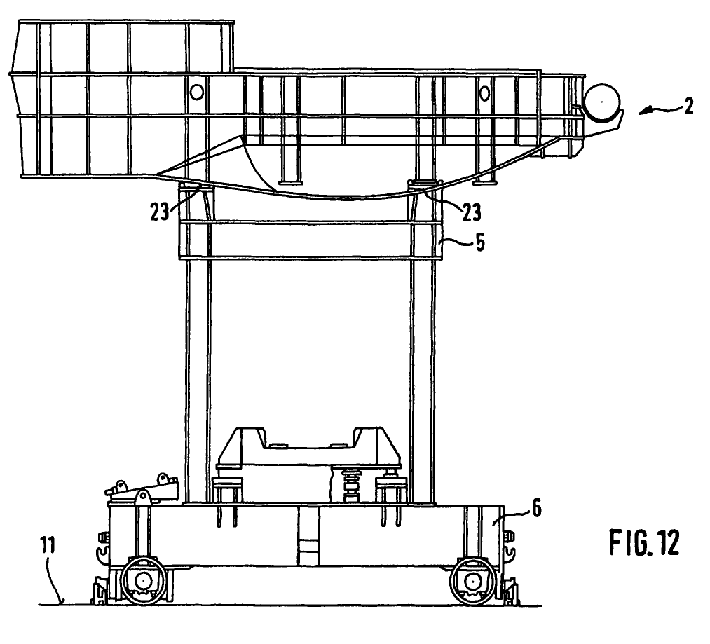

FIG. 10 shows a partial section through the vessel lifting device.

FIG. 11 shows the transporter moved in during the transfer of the lower vessel.

FIG. 12 shows the transporter being moved out with the lower vessel supported on it.

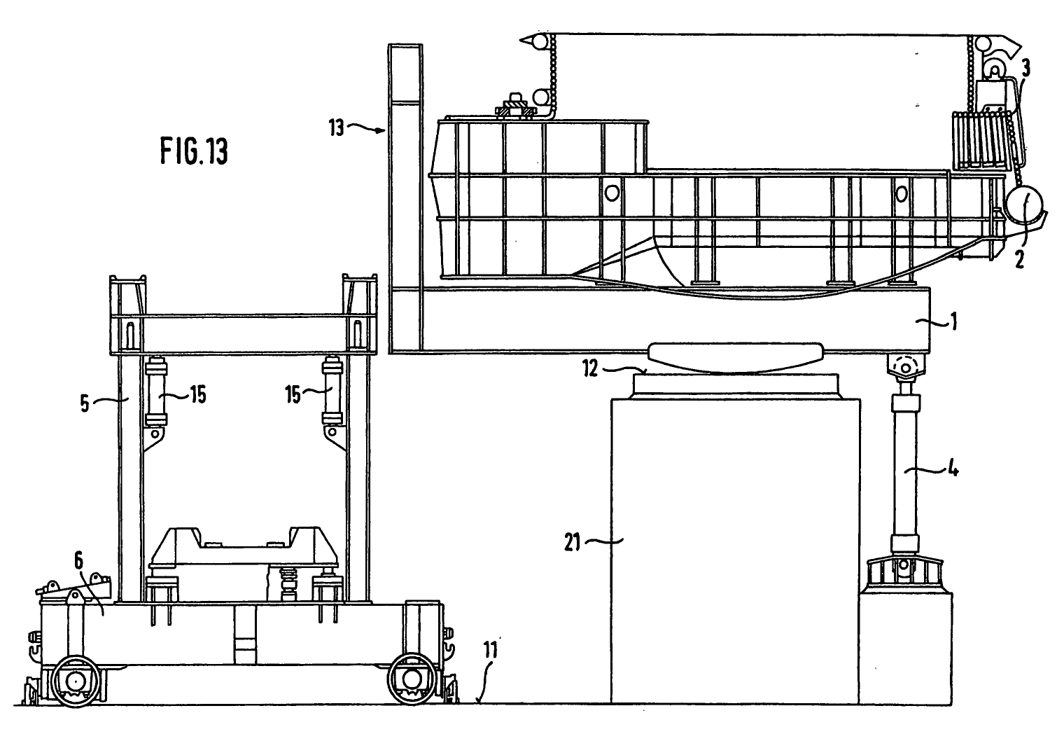

FIG. 13 shows an alternative embodiment of the transporter without a lockable tilting bearing on the tilting frame.

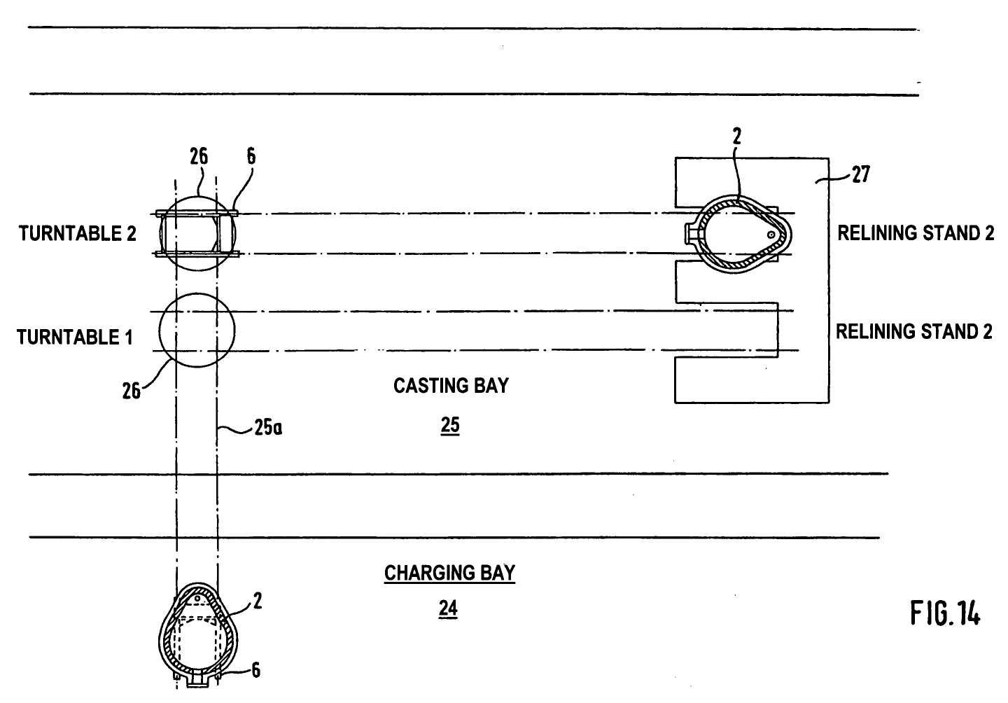

FIG. 14 shows a ground plan of the track through the casting bay with turntable and tracks to a relining stand.

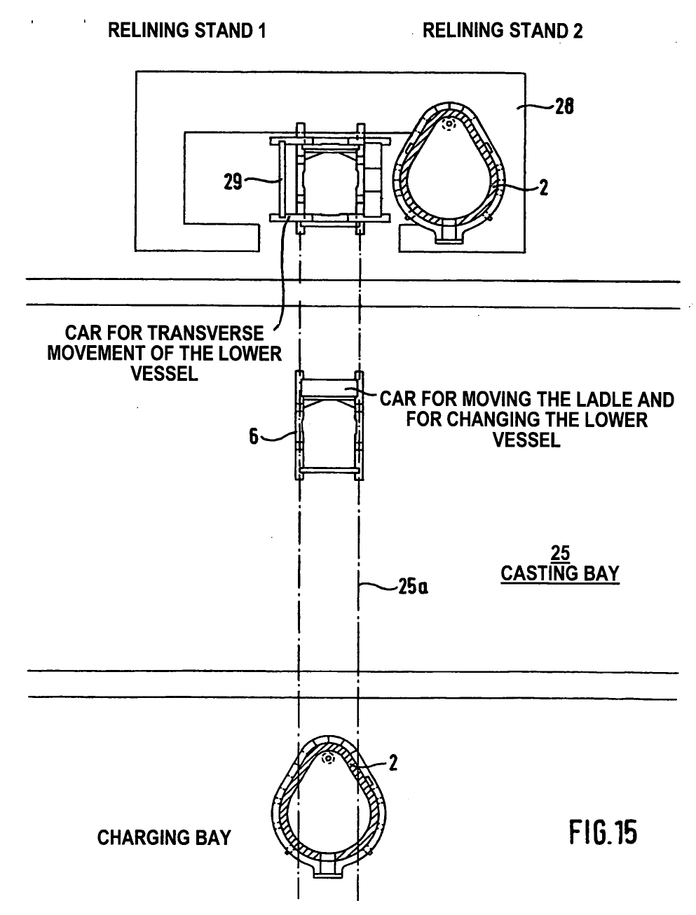

FIG. 15 shows a ground plan of the track guidance in the casting bay to the relining stand with a cross-transfer car.

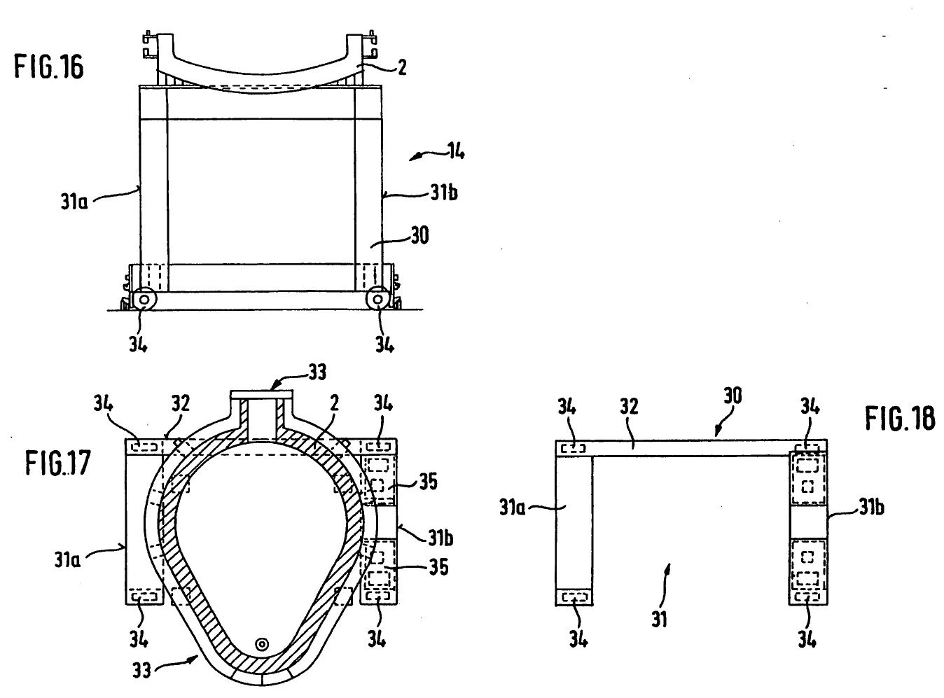

FIG. 16 shows a front view of the independent transporter as a relining stand.

FIG. 17 shows a top view corresponding to FIG. 16 with the lower vessel placed on it.

FIG. 18 shows a top view of the transporter without the lower vessel.

In the method for disassembling or assembling structural components of an electric arc furnace, the furnace cover is lifted by a jib and swung out, or it is only lifted to free the space above the upper vessel 3. The media and power supply lines and the measuring leads are disconnected from the upper vessel 3 and/or from the lower vessel 2 and are reconnected after the assembly. The basic procedure is as follows: After it has been separated from the lower vessel 2, the upper vessel 3 either remains in its position or, after disconnection of the media and power supply lines and measuring leads, is lifted and moved out by the charging crane; the lower vessel 2 is lowered and moved out by a transporter 6; and after the vessel relining and after the lower vessel 2 has been moved back in, the upper vessel 3 and the lower vessel 2 are rejoined after the disconnected media and power supply lines and measuring leads have first been reconnected. In this situation (FIG. 1), the furnace shell 13 rests on a tilting frame 1, which is supported by a bearing, e.g., by cradle or tilting bearings 12, on a foundation block 21. The tilting frame 1 can be adjusted to swivel positions by a piston-cylinder unit 4. The transporter 6 with a lower vessel changing frame 5 is moved on the mill floor level 11 and is assigned to the furnace shell 13. The following procedure is used to change a furnace shell 13:

the lower vessel 2 and the upper vessel 3 are raised from the initial position shown in the drawing (FIG. 1);

the transporter 6 with the lower vessel changing frame 5, which receives the lower vessel 2, is moved under the lower vessel 2 in the disassembly position;

the lower vessel 2 and the upper vessel 3 are lifted (FIG. 3) by a vessel lifting device 7 (FIG. 2) and lowered together (FIG. 4);

the upper vessel 3 is raised (FIG. 5), so that it can be moved out by the charging crane; and

the lower vessel 2 is moved out with the transporter 6.

In this connection, the transporter 6 is waiting in the standby position in the tapping area (FIG. 1), and the lower vessel changing frame 5 on the transporter 6 is adjusted to a transfer height under* the lower vessel 2.

The transporter 6 with the lower vessel 2 resting on the lower vessel changing frame 5 is taken into the casting bay 25 (FIGS. 6 and 7).

This handling is made possible by the vessel lifting device 7 shown in FIGS. 2 to 5, which comprises tilting cylinder-piston drives 16 distributed around the periphery. Connection with the given vessel structural component is established by means of detachable bolts A, B, of which the connecting device 19 (bolt A) is engaged on a height adjustment device 18, i.e., on a support bar mounted on the piston rod 17.

In this regard, a first crossbar of the lower vessel 2 is connected with the connecting devices 19, and a second crossbar of the upper vessel 3 is connected with the connecting-devices 20 (bolts B).

With bolt B moved in, the upper vessel 3 can be raised. With bolt A moved in, the lower vessel 2 can be raised and then, after the transporter 6 has been moved in, it can be lowered onto the transporter 6 and moved out.

In accordance with a second procedure, the following steps (FIG. 8) are carried out:

a tilting bearing 8 for the tilting frame 1, which supports the furnace shell 13, is locked;

the upper vessel 3 is raised without disconnecting the media and power supply lines and measuring leads;

the lower vessel 2 and the upper vessel 3 are tilted out of the initial position into a tilted position (FIG. 9) on the cradle bearing 12;

the transporter 6 with the lower vessel changing frame 5 is moved under the lower vessel 2 in the disassembly position;

the tilting frame 1 is swung back into the initial position until the lower vessel sets down on the lower vessel changing frame 5; and

the lower vessel 2 is taken by the transporter 6 to a relining stand 27 or 28.

Here too, the transporter 6 with the lower vessel changing frame 5 is held in the standby position in the tapping area (FIG. 8).

As the detail enlargement “X” in FIG. 8 shows, the vessel feet 22 are provided with a convex support surface 23 facing the tilting frame 1.

While the tilting bearing 8 is locked to prevent swiveling, the lock is disengaged during the melting operation, so that the melting operation can proceed as usual. The tilting bearing 8 rests on the foundation block 21. The swiveling of the tilting frame is accomplished by the tilting cylinder-piston unit 4 (FIG. 9). The disassembly (detachment and lifting) of the upper vessel 3 from the lower vessel 2 is accomplished by the vessel lifting device 7 with the piston-cylinder drive 16 and the piston rod 17. The movement of the tilting cylinder-piston unit 4 raises the tilting frame 1 sufficiently high that the cradle bearing 12 is freed, and the upper vessel 3 is lifted by the piston rod 17 of the piston-cylinder drive 16 (after it has been detached from the lower vessel 2). Here too, then, with the bolt B moved out, the upper vessel 3 can be released, and with bolt A moved in, the lower vessel 2 is set down on the transporter 6 and moved out (FIG. 10).

The tilting bearing 8 and the bearing of the tilting cylinder-piston unit 4 are supported by and mounted on the foundation block 21.

FIG. 11 shows the transporter 6 ready to be moved out after the tilting cylinder-piston unit 4 has been returned to its initial position. The transporter 6 is ready to be moved out at the mill floor level 11 and is moved out loaded only with the lower vessel 2, as FIG. 12 shows.

In an alternative embodiment illustrated in FIG. 13, the transporter 6 has its own piston-cylinder units 15, which act on the lower vessel changing frame 5.

In accordance with another (third) method, the following steps are carried out (FIG. 14):

the lower vessel 2 is moved on the transporter 6 from the charging bay 24 to the casting bay 25 on the casting bay track 25a;

the transporter 6 is turned on a turntable 26 and moved on an aligned track into a first relining stand 27; and

the lower vessel 2 is set down by lowering it into the first relining stand 27.

The lower vessel 2 can be lowered onto a cross-transfer car 29 in the casting bay 25 between two relining stands 27, the cross-transfer car 29 can be moved into one of the relining stands 27, and the lower vessel 2 can be set down, for example, by the piston cylinder units 15 and a lower vessel changing frame 5.

As shown in FIG. 15, the lower vessel 2 can be moved by the transporter 6 into an alternative relining stand 28, in which it is transferred from the transporter 6 onto a cross-transfer car 29, which can be moved left or right into a relining stand 28, in which the lower vessel 2 is lowered as described above. The relining stand 28 is designed in such a way with a central path of the casting bay track 25a, that the cross-transfer car 29 can be optionally moved into two opposite relining stands 28 without interfering with a lower vessel 2 already present in the relining stand.

FIGS. 16 to 18 show a transporter 30, which is designed as a movable relining stand 14. This relining stand 14 has a basic U-shape 31, in which the lower vessel 2 is supported on the two legs 31a, 31b of the U and on a cross frame 32 that joins the two legs 31a, 31b of the U. In this regard, the lower vessel 2 is supported in its assembly or disassembly position 33, in which it was moved out, and later can be moved back in again without being rotated. The track wheels 34 of the transporter 30 are rotationally supported in pairs in the end regions of the legs of the U. The transporter 30, which is shown in FIG. 18 without the lower vessel 2 and serves as the “relining stand”, has sufficient space in one of the legs 31a, 31b of the basic U shape 31 to house a drive 35 for the track wheels 34.

The transporter 30 can be stationed as a relining stand in any desired station of the casting bay 25 in which the necessary power supply and the supply or relining material can easily be made available.

### List of Reference Numbers

1 tilting frame

2 lower vessel

3 upper vessel

4 tilting cylinder-piston unit

5 lower vessel changing frame 5

6 transporter

7 vessel lifting device

8 lockable tilting bearing

11 mill floor level

12 cradle bearing

13 furnace shell

14 movable relining stand

15 piston-cylinder unit (transporter)

16 piston-cylinder drive (vessel lifting device)

17 piston rod

18 height adjustment device

19 connecting device

20 connecting device

21 foundation block

22 vessel foot

23 convex support surface

24 charging bay

25 casting bay

25a casting bay track

26 turntable

27 first relining stand

28 second relining stand

29 cross-transfer car

30 transporter

31 basic U-shape

31a leg of U

31b leg of U

32 cross frame

33 assembly/disassembly position

34 track wheels

35 drive

1. Method for disassembling or assembling structural components of an electric arc furnace, in which the furnace cover is lifted and swung out or is only lifted, and in which the media and power supply lines and the instrument leads are disconnected from the upper vessel and/or the lower vessel during the disassembly and reconnected after the assembly, wherein, after it has been separated from the lower vessel (2), the upper vessel (3) either remains in its position or, after disconnection of the media and power supply lines and instrument leads, is lifted by tilting and moved out by the charging crane; that the lower vessel (2) is lifted and then lowered and moved out by a transporter (6);
and that, after the lower vessel (2) has been moved back in, the upper vessel (3) and the lower vessel (2) are rejoined once the disconnected media and power supply lines and instrument leads have been reconnected.

2. Method in accordance with claim 1, wherein the following modified steps:
the lower vessel (2) and the upper vessel (3) are lifted from an initial position,
a transporter (6) with a lower vessel changing frame (5) is moved under the lower vessel (2) in the disassembly position,
the lower vessel (2) and the upper vessel (3) are lowered onto the transporter (6) by a vessel lifting device (7),
the upper vessel (3) is separated from the lower vessel (2) and lifted again with the vessel lifting device (7), and
the lower vessel (2) is moved out with the transporter (6).

3. Method in accordance with claim 1, wherein a lower vessel changing frame (5) on the transporter (6), which is waiting in the standby position in the tapping area, is adjusted to a transfer height in front of the lower vessel (2).

4. Method in accordance with claim 1, wherein detachable bolts (A, B) located on the vessel lifting device (7), which is supported on the periphery, are operated with a piston rod (17) for joining or for detaching the lower vessel (2) and/or the upper vessel (3).

5. Method in accordance with claim 1, wherein, with the bolt (B) moved in, the upper vessel (3) is raised.

6. Method in accordance with claim 1, wherein, with the bolts (A, B) moved in, the lower vessel (2) and the upper vessel (3) are lifted, or, with the bolt (A) moved in, the lower vessel (2) is lowered onto the transporter (6) and moved out.

7. Method in accordance with claim 1, wherein the following steps:
a tilting bearing (8) for a tilting frame (1) is locked,
the upper vessel (3) is raised without disconnecting the media and power supply lines and the measuring leads,
the lower vessel (2) is tilted out of the initial position into a position on the cradle bearing or tilting bearing (12),
a transporter (6) with a lower vessel changing frame (5) is moved under the lower vessel (2) in the disassembly position,
the tilting frame (1) is swung back into the initial position until the lower vessel (2) has been set down on the lower vessel changing frame (5), and
the lower vessel (2) is moved out to a relining stand (27 or 28) by the transporter (6).

8. Method in accordance with claim 7, wherein the transporter (6) with the lower vessel changing frame (5) is held in a standby position in the tapping area.

9. Method in accordance with claim 7, wherein individual bolts (A, B) located on the vessel lifting devices (7), which are supported on the periphery of the vessel, are operated with the piston rod (17) for joining or for detaching the lower vessel (2) and/or the upper vessel (3).

10. Method in accordance with claim 1, wherein the following steps:
the lower vessel (2) is moved on the transporter (6) from the charging bay (24) to the casting bay (25),
the transporter (6) is turned on a turntable (26) and moved on an aligned track to a first relining stand (27), and
the lower vessel (2) is set down by lowering it into the first relining stand (27).

11. Method in accordance with claim 10, wherein the lower vessel (2) is lowered onto a cross-transfer car (29) in the casting bay (25) between two relining stands (27), the cross-transfer car (29) is moved into one of the relining stands (27), and the lower vessel (2) is set down.

12. Changing device for the disassembly or assembly of structural components of an electric arc furnace, with a boom for the furnace cover and cradles for the tiltable furnace shell, which move with rolling contact on a bearing surface, and with means for moving out a vessel structural component, wherein the furnace shell (13) can be set in disassembly or assembly positions by means of a tilting cylinder-piston unit (4), which acts on a tilting frame (1), and/or by means of vessel lifting devices (7), which are distributed around the periphery of the furnace shell (13) and can be joined with or detached from the lower vessel (2) and/or the upper vessel (3).

13. Changing device in accordance with claim 12, wherein a transporter (6), which travels on tracks (25a) between the charging bay (24) and the casting bay (25), is assigned to the tilting frame (1) at the height level of the tilting frame (1).

14. Changing device in accordance with claim 13, wherein the transporter (6) can be moved together with a lower vessel changing frame (5) at the level of the mill floor (11).

15. Changing device in accordance with claim 13, wherein the transporter (6) has a lower vessel changing frame (5) that can be adjusted in height by means of several piston-cylinder units (15).

16. Changing device in accordance with claim 12, wherein each of the vessel lifting devices (7) consists of a piston-cylinder drive (16), whose piston rod (17) is provided with a device (18) for adjusting the height and with releasable connecting devices (19, 20) for the lower vessel (2) and/or the upper vessel (3).

17. Changing device in accordance with claim 13, wherein the tilting frame (1) is supported at the opposite end from the tilting cylinder-piston unit (4) by means of a lockable tilting bearing (8) on a foundation block (21).

18. Changing device in accordance with claim 12, wherein the lower vessel (2) is supported on the tilting frame (1) by vessel feet (22) that form convex support surfaces (23).

19. Changing device in accordance with claim 12, wherein the transporter (6) can be moved from the charging bay (24) on a casting bay track (25a) and then via a turntable (26) into the first relining stand (27), in which the lower vessel (2) can be set down or picked up again by means of the piston-cylinder units (15) of the transporter (6).

20. Changing device in accordance with claim 12, wherein the lower vessel (2) can be moved by the transporter (6) into a second relining stand (28), in which it can be transferred from the transporter (6) to a cross-transfer car (29), from which the lower vessel (2) can be set down or picked up again in the second relining stand (28).

21. Changing device in accordance with claim 12, wherein the cross-transfer car (29) can be optionally moved into two opposite relining stands (28).

22. Changing device in accordance with claim 12, wherein a transporter (30) is designed as a movable relining stand (14) with a basic U-shape (31).

23. Changing device in accordance with claim 22, wherein in the basic U-shape (31) the lower vessel (2) is supported on the two legs (31a, 31b) of the U and on a cross frame (32) joining the legs (31a, 31b) of the U.

24. Changing device in accordance with claim 22, wherein the lower vessel (2) is supported between the two legs (31a, 31b) of the U in the assembly or disassembly state (33).

25. Changing device in accordance with claim 22, wherein the track wheels (34) of the transporter (30) are rotationally supported in pairs in the end regions of the legs (31a, 31b) of the U.

26. Changing device in accordance with claim 25, wherein a drive (35) for the track wheels (34) is installed in at least one of the legs (31a, 31b) of the U of the basic U shape (31).
